(19) United States
(12) Patent Application Publication
(10) Pub. No.: US 2026/0222833 A1
(43) Pub. Date: Jul. 30, 2026

(54) AUTONOMOUS DENIAL TECHNIQUES FOR IN-DEVICE COEXISTENCE INTERFERENCE IN NON-TERRESTRIAL NETWORKS

(71) Applicant: QUALCOMM Incorporated, San Diego, CA (US)

(72) Inventors: Bharat SHRESTHA, San Diego, CA (US); Sherif ELAZZOUNI, San Diego, CA (US); Toni Harri Henrikki LAEHTEENSUO, Helsinki (FI)

(21) Appl. No.: 19/040,685

(22) Filed: Jan. 29, 2025

(51) Int. Cl. H04W 24/02; H04W 72/20; H04W 84/06

(52) U.S. Cl. CPC H04W 24/02; H04W 72/20; H04W 84/06

(57) ABSTRACT

Methods, systems, and devices for wireless communications are described. In some examples, autonomous denial techniques may be dynamically activated and deactivated based on the presence of in-device coexistence (IDC) interference. For example, a user equipment (UE) may transmit a message indicating IDC interference associated with non-terrestrial network (NTN) communications. The UE may receive a first control message that includes an indication to activate one or more autonomous denial configurations, which may be activated during one or more time intervals (e.g., global navigation satellite system (GNSS) reception windows). In such cases, the UE may receive GNSS signaling during the one or more time intervals and when the one or more autonomous denial configurations are activated. In some examples, the UE may transmit an indication that the IDC interference is no longer affecting the NTN communications, and the UE may receive another control message deactivating the one or more autonomous denial configurations.

### FIELD OF TECHNOLOGY

The following relates to wireless communications, including autonomous denial techniques for in-device coexistence interference in non-terrestrial networks.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting a first message indicating in-device coexistence interference associated with non-terrestrial network communications, receiving, based on the first message, a first control message including an indication to activate one or more autonomous denial configurations, and receiving one or more global navigation satellite system (GNSS) signals during at least one GNSS reception window, where the one or more autonomous denial configurations are activated for the at least one GNSS reception window in accordance with the first control message.

A UE for wireless communications is described. The UE may include one or more memories storing processor executable code, and one or more processors coupled with the one or more memories. The one or more processors may individually or collectively be operable to execute the code to cause the UE to transmit a first message indicating in-device coexistence interference associated with non-terrestrial network communications, receive, based on the first message, a first control message including an indication to activate one or more autonomous denial configurations, and receive one or more GNSS signals during at least one GNSS reception window, where the one or more autonomous denial configurations are activated for the at least one GNSS reception window in accordance with the first control message.

Another UE for wireless communications is described. The UE may include means for transmitting a first message indicating in-device coexistence interference associated with non-terrestrial network communications, means for receiving, based on the first message, a first control message including an indication to activate one or more autonomous denial configurations, and means for receiving one or more GNSS signals during at least one GNSS reception window, where the one or more autonomous denial configurations are activated for the at least one GNSS reception window in accordance with the first control message.

A non-transitory computer-readable medium storing code for wireless communications is described. The code may include instructions executable by one or more processors to transmit a first message indicating in-device coexistence interference associated with non-terrestrial network communications, receive, based on the first message, a first control message including an indication to activate one or more autonomous denial configurations, and receive one or more GNSS signals during at least one GNSS reception window, where the one or more autonomous denial configurations are activated for the at least one GNSS reception window in accordance with the first control message.

Some examples of the method, UEs, and non-transitory computer-readable medium described herein may further include operations, features, means, or instructions for transmitting a second message indicating an absence of the in-device coexistence interference associated with the non-terrestrial network communications and receiving, based on the second message, a second control message including an indication to deactivate the one or more autonomous denial configurations.

In some examples of the method, UEs, and non-transitory computer-readable medium described herein, the first message includes an indication of one or more autonomous denial validity windows during which the one or more autonomous denial configurations are to be activated.

Some examples of the method, UEs, and non-transitory computer-readable medium described herein may further include operations, features, means, or instructions for transmitting one or more signals indicating that the UE may be ready to transmit one or more uplink messages and receiving, based on the one or more signals, an uplink grant scheduling resources for transmitting the one or more uplink messages.

In some examples of the method, UEs, and non-transitory computer-readable medium described herein, the one or more signals may be transmitted after receiving the one or more GNSS signals and prior to an expiration of an autonomous denial validity window of the one or more autonomous denial validity windows.

Some examples of the method, UEs, and non-transitory computer-readable medium described herein may further include operations, features, means, or instructions for receiving an uplink grant scheduling resources for transmitting one or more uplink messages, where the uplink grant may be received after an expiration of an autonomous denial validity window of the one or more autonomous denial validity windows.

In some examples of the method, UEs, and non-transitory computer-readable medium described herein, the one or more autonomous denial configurations each include a first threshold quantity of autonomous denial instances associated with an autonomous denial validity window and the first threshold quantity of autonomous denial instances may be greater a second threshold quantity of autonomous denial instances.

In some examples of the method, UEs, and non-transitory computer-readable medium described herein, the first control message includes an indication of one or more starting instances and one or more ending instances associated with activating the one or more autonomous denial configurations.

Some examples of the method, UEs, and non-transitory computer-readable medium described herein may further include operations, features, means, or instructions for receiving one or more control messages indicating a set of autonomous denial configurations, where the one or more autonomous denial configurations indicated by the first control message may be from the set of autonomous denial configurations.

Some examples of the method, UEs, and non-transitory computer-readable medium described herein may further include operations, features, means, or instructions for transmitting a third message requesting an autonomous denial configuration from the set of autonomous denial configurations for activation during the at least one GNSS reception window, where the indication to activate the one or more autonomous denial configurations may be based on the third message, the one or more autonomous denial configurations including the autonomous denial configuration.

In some examples of the method, UEs, and non-transitory computer-readable medium described herein, the first control message indicates which autonomous denial configuration from the set of autonomous denial configurations are to be activated during the at least one GNSS reception window.

Some examples of the method, UEs, and non-transitory computer-readable medium described herein may further include operations, features, means, or instructions for transmitting a capability message that indicates that the UE supports the one or more autonomous denial configurations for the at least one GNSS reception window.

Some examples of the method, UEs, and non-transitory computer-readable medium described herein may further include operations, features, means, or instructions for receiving one or more messages indicating whether one or more cells support the one or more autonomous denial configurations for the at least one GNSS reception window, where the first message may be transmitted to a network entity associated with a cell of the one or more cells that supports the one or more autonomous denial configurations.

Some examples of the method, UEs, and non-transitory computer-readable medium described herein may further include operations, features, means, or instructions for selecting one or more cells that support the one or more autonomous denial configurations for the at least one GNSS reception window based on a ranking of the one or more cells.

Some examples of the method, UEs, and non-transitory computer-readable medium described herein may further include operations, features, means, or instructions for receiving an indication of whether one or more neighboring cells support the one or more autonomous denial configurations and selecting a cell of the one or more neighboring cells based on the cell supporting the one or more autonomous denial configurations.

Some examples of the method, UEs, and non-transitory computer-readable medium described herein may further include operations, features, means, or instructions for receiving one or more control messages configuring a set of GNSS reception windows, where the one or more autonomous denial configurations may be activated for the at least one GNSS reception window based on the set of GNSS reception windows.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports autonomous denial techniques for in-device coexistence (IDC) interference in non-terrestrial networks (NTNs) in accordance with one or more aspects of the present disclosure.

FIG. 2 shows an example of a wireless communications system that supports autonomous denial techniques for IDC interference in NTNs in accordance with one or more aspects of the present disclosure.

FIG. 3 shows an example of global navigation satellite system reception windows that support autonomous denial techniques for IDC interference in NTNs in accordance with one or more aspects of the present disclosure.

FIG. 4 shows an example of a process flow that supports autonomous denial techniques for IDC interference in NTNs in accordance with one or more aspects of the present disclosure.

FIGS. 5 and 6 show block diagrams of devices that support autonomous denial techniques for IDC interference in NTNs in accordance with one or more aspects of the present disclosure.

FIG. 7 shows a block diagram of a communications manager that supports autonomous denial techniques for IDC interference in NTNs in accordance with one or more aspects of the present disclosure.

FIG. 8 shows a diagram of a system including a device that supports autonomous denial techniques for IDC interference in NTNs in accordance with one or more aspects of the present disclosure.

FIGS. 9 through 11 show flowcharts illustrating methods that support autonomous denial techniques for IDC interference in NTNs in accordance with one or more aspects of the present disclosure.

### DETAILED DESCRIPTION

Wireless communication devices (such as a user equipment (UE)) may support various types of communication technologies including fourth generation (4G) technologies (e.g., Long Term Evolution (LTE), LTE-Advanced (LTE-A), LTE-A Pro) and fifth generation (5G) technologies (e.g., New Radio (NR), non-terrestrial network (NTN) communications), as well as one or more other wireless technologies, such as global navigation satellite system (GNSS) communications technologies. An NTN may be a communication network that utilizes space-based (e.g., satellites) and/or airborne platforms (e.g., high-altitude platforms, unmanned aerial vehicles (UAVs)) to provide connectivity for wireless communication devices. Such networks may be used in locations, for example, where terrestrial networks may not be feasible or economical. In some cases, an NTN may supplement terrestrial networks. A UE that supports NTN communication may communicate with one or more network entities (e.g., NTN satellites), and the UE may additionally receive downlink signaling from one or more navigation satellites (e.g., GNSS satellites), where the downlink signaling may be used to maintain synchronization for communications.

In some cases, however, a device supporting NTN communications may experience in-device coexistence (IDC) interference. IDC interference may refer to interference that occurs when multiple wireless communications technologies operate (e.g., simultaneously) within a same wireless communication device. For example, uplink transmissions from the UE to one or more network entities (e.g., NTN satellites) may cause IDC interference with reception of downlink GNSS signaling, which may impact the UE's ability to decode the GNSS signaling and maintain synchronization. Here, the IDC interference may be due to a proximity of a GNSS signaling band (e.g., a band between about 1597.5 megahertz (MHz) and 1605.9 MHz) to an NTN signaling band (e.g., a band between about 1626.5 MHz and about 1660.5 MHz, an N 255 band).

While some techniques may be used to avoid or mitigate IDC interference, such techniques may be inadequate for IDC interference experienced with relation to NTN communications. For example, a UE may only support the N255 band for NTN communications and, as such, the UE may be unable to switch to another NTN band (such as an N254 band or an N256 band) when receiving the GNSS signaling. Additionally, while some techniques may utilize discontinuous reception (DRX) to mitigate IDC interference, a DRX cycle may not appropriately align with the reception of GNSS signaling, thereby preventing such techniques from aiding in IDC mitigation. Moreover, IDC interference may be caused by the UE's own uplink transmissions to an NTN network entity (e.g., NTN satellite), the UE may accordingly be in an active state, resulting in DRX being ineffectual in preventing the IDC interference for NTN communications.

As described herein, techniques may enable the dynamic activation and deactivation of one or more autonomous denial configurations, which may be used to limit (or prevent) uplink signaling from the UE when one or more downlink signals are expected to be received by from a GNSS (e.g., during a GNSS reception window). For example, the UE may be aware of respective GNSS reception windows during which GNSS signaling may be received (e.g., for timing synchronization). The UE may detect IDC interference caused by an uplink transmission to an NTN network entity and downlink reception of GNSS signaling, and the UE may transmit a message to a network entity indicating that the IDC interference has been detected (e.g., an IDC issue exists). The UE may receive, from the network entity, a control message that activates one or more autonomous denial configurations, which may be activated during at least one of the GNSS reception windows. In such examples, the autonomous denial configuration may be relatively more aggressive compared to conventional autonomous denial techniques (e.g., the UE may be configured with a relatively higher quantity of possible denial instances within a validity window), thereby enabling the UE to autonomously deny relatively more uplink resources within a validity window (which may correspond to the GNSS reception window).

In some aspects, the UE may indicate which GNSS reception windows in which the (aggressive) autonomous denial configuration may be activated. After receiving the GNSS signaling, the UE may either notify the network entity that the UE is ready to transmit uplink signaling (e.g., at the end of the validity window) or the UE may monitor for a grant that schedules resources for the uplink signaling. Additionally, or alternatively, the UE may be configured with one or more autonomous denial configurations that enable relatively aggressive denials of uplink resources, where each configuration may be associated with a starting instance (e.g., a starting system frame number (SFN)) and an ending instance (e.g., an ending SFN). In some examples, once the IDC interference is no longer detected by the UE, the UE may transmit an indication of an absence of an IDC issue (e.g., the IDC interference is no longer detected), and the network entity may transmit a control message that deactivates the (aggressive) autonomous denial configurations. In any case, the UE may activate relatively aggressive autonomous denial configurations for one or more GNSS reception windows, which may enable the UE to avoid uplink transmissions that may otherwise cause IDC interference with GNSS signaling.

Aspects of the present disclosure may be implemented to realize one or more potential advantages. For example, by supporting signaling that enables the dynamic activation and deactivation of autonomous denial configurations, a wireless communications system may enable robust GNSS signal reception techniques, which may ensure persistent synchronization for wireless communication devices receiving GNSS signaling. The described techniques may also enable coordination between a UE and one or more cells, where a UE may receive signaling that indicates which cells support the dynamic activation/deactivation of autonomous denials, and the UE may efficiently select one or more cells based on whether those cells support such techniques. Moreover, the described techniques may minimize signaling overhead by enabling a UE to dynamically request an aggressive autonomous denial configuration be activated only when interference (e.g., IDC interference) is present. As such the techniques described herein may enable improved operations by wireless communication devices resulting from the mitigation or removal of IDC interference (e.g., for NTN-based communications).

Aspects of the disclosure are initially described in the context of wireless communications systems. Further aspects are described in the context of GNSS reception windows and a process flow. Aspects of the disclosure are further illustrated by and described with reference to apparatus diagrams, system diagrams, and flowcharts that relate to autonomous denial techniques for IDC interference in NTNs.

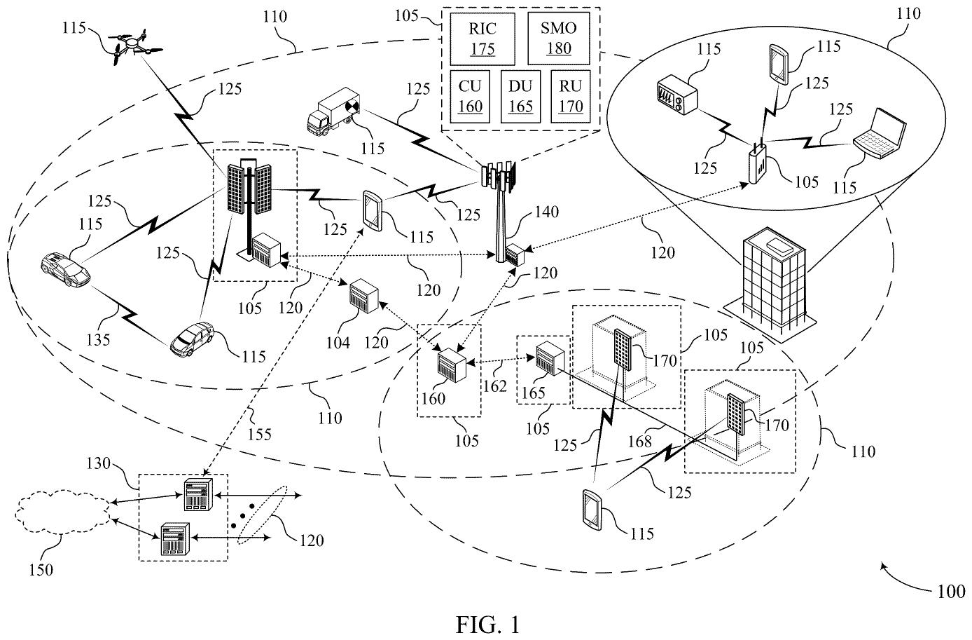

FIG. 1 shows an example of a wireless communications system 100 that supports autonomous denial techniques for IDC interference in NTNs in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support autonomous denial techniques for IDC interference in NTNs as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS device based on, for example, global positioning system (GPS), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ⋅N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by an SFN (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

The wireless communications system 100 may support NTN communications or may be an example of an NTN and, in some cases, one or more of the network entities 105 may be an example of an entity of an NTN. An NTN may be a communication network that utilizes space-based (e.g., satellites) and/or airborne platforms (e.g., high-altitude platforms, unmanned aerial vehicles (UAVs)) to provide connectivity for wireless communication devices. For example, an NTN may refer to a wireless communications network that supports various space-borne and/or aerial communications, which may include Geostationary Earth Orbit (GEO) satellite constellations, Medium Earth Orbit (MEO) satellite constellations, Low Earth Orbit (LEO) satellite constellations, high-altitude platform systems (HAPS), low-altitude platform systems (LAPS), air-to-ground (A2G) networks, among other examples. As such, a network entity 105 may be an example of a satellite or another entity (e.g., an aircraft, an unmanned aerial vehicle (UAV) (which may be referred to as a drone or other similar terminology), or the like) of an NTN, which may support improved connectivity and broader coverage, among other benefits. NTNs may be used in locations where terrestrial networks may not be feasible or economical. In some cases, one or more NTNs may be utilized to supplement terrestrial networks. In some examples, NTNs may implement various techniques that enable enhanced synchronization between a UE 115 and a network entity 105 of the NTN.

A network entity 105 may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may support the dynamic activation and deactivation of autonomous denial configurations based on the presence or absence of IDC interference. For example, a UE 115 may transmit a message indicating IDC interference associated with NTN communications. The UE 115 may receive a first control message from a network entity 105 that includes an indication to activate one or more autonomous denial configurations. Here, at least one autonomous denial configuration may be activated during one or more time intervals (e.g., during one or more GNSS reception windows), which may enable the UE 115 to deny one or more uplink resources (e.g., symbols, slots, or the like), thereby avoiding uplink transmissions that may contribute to the IDC interference. In such cases, the UE may receive GNSS signaling during the one or more time intervals and when the one or more autonomous denial configurations are activated, enabling efficient decoding of the GNSS signals, thereby providing for a robust GNSS synchronization scheme. In some examples, the UE 115 may transmit, to the network entity 105, an indication that the IDC interference is no longer affecting the NTN communications, and the UE 115 may receive another control message deactivating the one or more autonomous denial configurations.

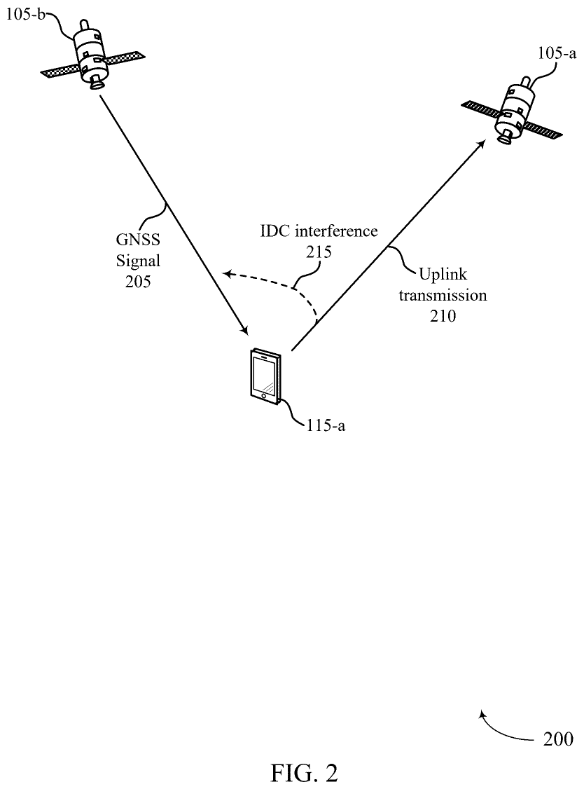

FIG. 2 shows an example of a wireless communications system 200 that supports autonomous denial techniques for IDC interference in NTNs in accordance with one or more aspects of the present disclosure. The wireless communications system 200 may be an example of a wireless communications system 100, as described herein with reference to FIG. 1. The wireless communications system 200 may include and/or implement some aspects of the wireless communications system 100. For example, the wireless communications system 200 may include a UE 115- a, which may be an example of a UE 115 described with reference to FIG. 1, and a network entity 105-a and a network entity 105-b, which may be examples of network entities 105 described with reference to FIG. 1. In some cases, the network entity 105-a may be an example of an NTN entity (e.g., associated with one or more NTN cells), as described herein. In some cases, the network entity 105-b may be an example of a GNSS network entity (e.g., associated with GNSS signaling and GNSS operations). The wireless communications system 200 may support techniques for dynamic activation and deactivation of one or more autonomous denial configurations (e.g., aggressive autonomous denial configurations).

The wireless communications system 200 may be an example of a network that supports NTN communications by one or more wireless communication devices, such as the UE 115-a. An NTN may be a communication network that utilizes space-based (e.g., satellites) and/or airborne platforms (e.g., high-altitude platforms, UAVs) to provide connectivity for wireless communication devices. Such networks may be used in locations, for example, where terrestrial networks may not be feasible or economical. One or more NTNs may be used to supplement terrestrial networks. As such, the UE 115-a may communicate uplink and downlink signaling with the network entity 105-a (e.g., an NTN satellite). As an example, an uplink transmission 210 from the UE 115-a to the network entity 105-a may be associated with NTN communications. NTN communications may be associated with transmission and reception of messages via one or more frequency bands (e.g., bands associated with non-terrestrial frequency range 1 (FR 1)) including, for example, an N254 band (e.g., about 1610 MHz-626.5 MHz for uplink, about 2483.5 MHz-500 MHz for downlink), an N255 band (e.g., about 1626.5 MHz-660.5 MHz for uplink, about 1525 MHz-559 MHz for downlink), and an N256 band (e.g., about 1980 MHz-010 MHz for uplink, about 2170 MHz-2200 MHz for downlink).

In some cases, the UE 115-a may additionally receive downlink signaling from the network entity 105-b (e.g., a navigation satellite, a GNSS satellite). As an example, the UE 115-a may receive one or more GNSS signals 205 from the network entity 105-b, where the one or more GNSS signals 205 may be used by the UE 115-a for synchronization purposes, among other uses. As an example, the UE 115-a supporting NTN may receive the one or more GNSS signals 205 in accordance with a periodicity to maintain uplink synchronization for NTN communications with the network entity 105-a. The one or more GNSS signals 205 may be received by the UE 115-a using one or more frequency bands including, for example, L1, L2, L5, E1, E5a, E5b, B1C, B2a, B2b, B3, G1, G2, L6/LEX, and S bands. For instance, the L1 band may be a frequency band used by a relatively large quantity of GNSS receivers, and the E1, E5a, and E5b bands may be associated with a Galileo-based navigation system/device. The G1 and G2 bands may be frequency bands associated with a GLONASS-based positioning system/device, and the L6/LEX bands may be associated with a quasi-zenith satellite system (QZSS)-based positioning system/device. Other bands and GNSSs may be possible.

The UE 115-a may thus support various types of communication technologies including, for example, 4G technologies (e.g., LTE, LTE-A, LTE-A Pro) and 5G technologies (e.g., NR, NTN), as well as GNSS communications technologies. In some cases, however, the UE 115-a may experience IDC interference 215 when using such technologies. The IDC interference 215 may refer to interference that occurs when multiple wireless communications technologies operate (e.g., simultaneously) within a same wireless communication device. For example, different radio technologies supported by the UE 115-a (e.g., a multifunctional device that integrates multiple wireless radios in relatively close proximity) may operate in overlapping or adjacent frequency bands, and simultaneous operation of such technologies may lead to interference. In particular, antennas associated with different radios of the UE 115-a may be located relatively close to one another (or may be shared), which may increase the chance for IDC interference. Additionally, or alternatively, different radio systems within the UE 115-a may transmit and receive signals that cause radio frequency interference with each other (e.g., if not properly isolated or filtered) and, in some cases, relative signals from one radio may modulate signals in another radio, leading to degradation in performance. Other aspects associated with the use of multiple radio technologies may also contribute to IDC interference. Thus, in some examples, the uplink transmission 210 from the UE 115-a to the network entity 105-a (e.g., an NTN satellite) may result in the IDC interference 215 that impacts the reception of the one or more GNSS signals 205. Such IDC interference 215 may affect the ability of the UE 115-a to properly decode the one or more GNSS signal 205, which may therefore cause issues with maintaining synchronization and may have an impact on communications by the UE 115-a.

Here, the IDC interference 215 may be based, at least in part, on a proximity of a GNSS signaling band to an NTN signaling band. For example, the frequency band used for the one or more GNSS signals 205 may be a band between about 1597.5 MHz and 1605.9 MHz (e.g., a GNSS L1 band), whereas a frequency band used for transmission and reception of NTN signaling (e.g., including the uplink transmission 210) may be a band between about 1626.5 MHz and about 1660.5 MHz (e.g., corresponding to the N255 band). As such, the NTN band used for the uplink transmission 210 may only be about 20 MHz from the GNSS L1 band, and leakage from the NTN signaling (such as the uplink transmission 210) may cause IDC interference 215 for the one or more GNSS signals 205 received by the UE 115-a.

While various techniques may be used to avoid or mitigate IDC interference, such techniques may be inadequate for the IDC interference 215 experienced with relation to NTN communications. For example, the UE 115-a may support only the N255 band for NTN communications and, as such, the UE 115-a may be unable to switch to another NTN band (such as the N254 band and/or the N256 band) when receiving the one or more GNSS signals 205. As such, frequency-division multiplexing (FDM)-based solutions to avoid or mitigate the IDC interference 215 may not be feasible in some scenarios.

Additionally, time-division multiplexing (TDM) techniques to reduce IDC interference 215 may utilize DRX. One or more DRX configurations and corresponding DRX cycles, however, may be misaligned with respect to the reception of the one or more GNSS signals 205 (e.g., a periodicity of the one or more GNSS signals 205), thereby preventing such techniques from aiding in IDC interference mitigation. Moreover, because the IDC interference 215 may be caused by the uplink transmission 210 from the UE 115-a (e.g., using the N255 band to an NTN satellite) being scheduled and/or being an ongoing transmissions, the UE 115-a may accordingly be in an active state for the transmission, and DRX configurations to limit the uplink transmission 210 may be ineffectual. In such cases, the UE 115-a may need to identify a DRX off duration or an active duration in which no uplink transmissions are scheduled or ongoing to enable the UE 115-a to receive the one or more GNSS signals 205. As such, DRX-based (or other TDM-based) solutions may not be effective in preventing the IDC interference 215 for NTN communications.

In some cases, the UE 115-a may support autonomous denial configurations, which may enable the UE 115-a to autonomously “deny” one or more resources associated with an uplink transmission. For example, the UE 115-a may be configured with one or more autonomous denial parameters, and the UE 115-a may accordingly consider itself to be allowed to deny any transmission in a particular uplink time interval (e.g., slot, symbol). Such transmissions may be denied if, during a quantity of time intervals indicated by a validity parameter (e.g., a parameter indicating a validity period or window over which the uplink autonomous denial time intervals may be counted, autonomousDenialValidity), preceding and including a particular time interval, the UE 115-a autonomously denied fewer uplink time intervals slots than a threshold indicated by a threshold parameter (e.g., a parameter indicating a threshold (e.g., maximum) quantity of uplink time intervals for which the UE 115-a is allowed to deny any uplink transmission, autonomousDenialSlots) within a same cell group. In some examples, the validity parameter may include a value (e.g., n) that indicate a quantity of time intervals. For instance, n200 may correspond to 200 slots, n500 may correspond to 500 slots, and so forth. Similarly, the threshold parameter may include a value (e.g., n) that indicate a quantity of time intervals. As an example, n2 may correspond to 2 slots, and n5 may correspond to 5 slots, and so forth. In some examples, the UE 115-a may calculate (e.g., sum) a quantity of denied uplink slots across a quantity of serving cells within a same cell group to determine whether the threshold quantity of time intervals is satisfied. In some cases, when multiple denied uplink time intervals at least partially overlap in the time domain, a quantity of denied uplink time intervals across all serving cells is counted as one denied uplink slot based on the relatively longest time interval.

In some cases, however, conventional autonomous denial techniques may not allow for a enough denials available to the UE 115-a to mitigate the IDC interference 215. For example, a configuration of the autonomous denial parameters may only allow the UE 115-a to deny up to about 10 percent of uplink resources (e.g., uplink transmissions) within a validity period. For instance, a conventional autonomous denial pattern may only allow the UE 115-a to deny uplink transmissions for 2 uplink time intervals (e.g., slots) out of 2000 total time intervals. Such autonomous denial configuration may not be sufficient for the UE 115-a to deny uplink transmissions while receiving the one or more GNSS signals 205, thereby being ineffectual in mitigating the IDC interference 215. Accordingly, relatively more aggressive autonomous denial configurations may be needed (e.g., with a quantity of allowed denials that is greater than conventional thresholds), which may enable the UE 115-a to deny a relatively greater quantity of time intervals (e.g., uplink resources) within a validity period for receiving the one or more GNSS signals 205 (and maintain uplink synchronization). In some examples of an aggressive autonomous denial configuration, up to 50 percent of a quantity of available time intervals (e.g., corresponding to a validity period) may be denied by the UE 115-a, whereas conventional autonomous denials may limit the denials to about 5-0 percent of the available time intervals. These values, however, are provided for illustrative purposes, and other examples of aggressive autonomous denial configurations and/or thresholds may be possible. That is, the examples provided herein should not be considered limiting to the scope of the claims or the disclosure.

Thus, one or more aspects of the present disclosure may enable the dynamic activation and deactivation of one or more “aggressive” autonomous denial configurations, which may be used to limit (or prevent) uplink signaling from the UE when one or more downlink signals are expected to be received by from a GNSS (e.g., during a GNSS reception window). Such aggressive autonomous denial configuration may be associated with a relatively greater quantity of allowed denials that the UE 115-a may use within a validity period, which may enable the UE 115-a sufficient time to receive the one or more GNSS signals 205. For example, the UE 115-a may be aware of respective GNSS reception windows during which the one or more GNSS signals 205 may be received (e.g., for timing synchronization). The UE 115-a may detect and IDC issue (e.g., the possibility of the IDC interference 215) caused by a scheduled or ongoing uplink transmission 210 to the network entity 105-a and downlink reception of the one or more GNSS signals 205. The UE 115-a may transmit a message to a network entity 105 indicating that the IDC interference 215 has been detected (e.g., the IDC issue exists, which may not be able to be resolved via one or more other techniques). The UE 115-a may receive, from the network entity 105, a control message that activates one or more autonomous denial configurations (e.g., aggressive autonomous denial configurations). The UE 115-a may activate the one or more autonomous denial configurations during at least one of the GNSS reception windows corresponding to the reception of the one or more GNSS signals 205. In such examples, the activated autonomous denial configuration used during the GNSS reception window(s) may be relatively more aggressive compared to conventional autonomous denial techniques (e.g., the UE 115-a may be configured with parameters enabling a relatively higher quantity of possible denial instances within a validity period), thereby enabling the UE 115-a to autonomously deny relatively more uplink resources (e.g., for any uplink transmission) within a validity period.

In some aspects, the UE 115-a may indicate which GNSS reception windows in which the (aggressive) autonomous denial configuration(s) may be activated. After receiving the GNSS signaling, the UE 115-a may either notify the network entity 105 that the UE 115-a is ready to transmit uplink signaling (e.g., at the end of the validity period) or the UE 115-a may monitor for a grant that schedules resources for the uplink signaling (e.g., an uplink grant). Additionally, or alternatively, the UE 115-a may be configured with one or more autonomous denial configurations that enable relatively aggressive denials of uplink resources, where each configuration may be associated with a starting instance (e.g., a starting SFN) and an ending instance (e.g., an ending SFN).

When the IDC interference 215 is no longer detected by the UE 115-a, the UE 115-a may transmit a message to the network entity 105 indicating an absence of the IDC issue (e.g., the IDC interference 215 is no longer detected, the IDC interference 215 may no longer affect one or more scheduled uplink transmissions), and the network entity 105 may transmit a control message that deactivates the one or more (aggressive) autonomous denial configurations. In any case, the UE 115-a may activate the relatively aggressive autonomous denial configurations for one or more GNSS reception windows, which may enable the UE 115-a to avoid uplink transmissions 210 that may otherwise cause IDC interference with the one or more GNSS signals 205.

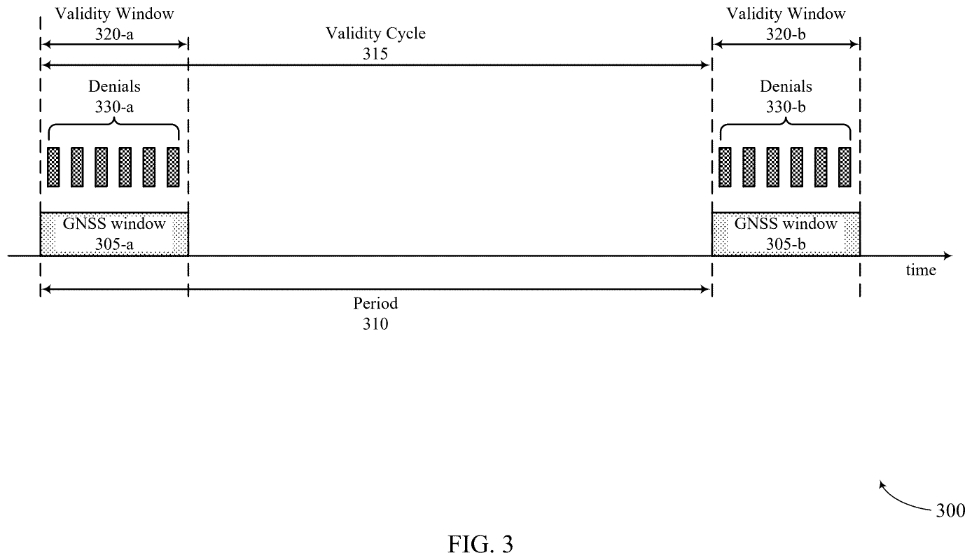

FIG. 3 shows an example of GNSS reception windows 300 that support autonomous denial techniques for IDC interference in NTNs in accordance with one or more aspects of the present disclosure. The GNSS reception windows 300 may implement or may be implemented by aspects of the wireless communications system 100 and/or the wireless communications system 200. For example, the GNSS reception windows 300 may be utilized by a UE 115, which may be an example of a UE 115 described with reference to FIGS. 1 and 2, for reception of downlink GNSS signaling. The GNSS reception windows 300 may support techniques for dynamic activation and deactivation of autonomous denial configurations (e.g., aggressive autonomous denial configurations).

In some examples, such as for NTN communications, a set of GNSS reception windows 305 (e.g., which may be referred to as GNSS windows or some other terminology) may be configured to enable the efficient reception of GNSS signaling by a UE 115 (e.g., for uplink synchronization). As an example, one or more GNSS reception windows (e.g., a GNSS reception window 305-a, a GNSS reception window 305-b, and so forth) may be configured in accordance with some periodicity. As an illustrative example, each period 310 of the GNSS reception windows 305 may be 10 seconds, and each GNSS reception window 305 may be 2 seconds. In such cases, within a 2 second GNSS reception window 305, a UE 115 may perform measurements for every 20 milliseconds (ms) periodicity (e.g., to receive downlink GNSS signaling). It is noted that other GNSS reception window durations and periodicities may be possible, and the examples described herein should not be considered limiting to the claims or the disclosure. In some cases, a UE 115 may transmit a message to a network entity that indicates the set of GNSS reception windows 305 and corresponding periodicity, which may be referred to as a GNSS cycle.

As described herein, a UE 115 may be configured with one or more autonomous denial configurations for receiving GNSS signaling, where an autonomous denial configuration may be activated for denying uplink transmissions during a GNSS reception window 305, thereby enabling the UE 115 to receive GNSS signaling during the corresponding GNSS reception window 305. The one or more autonomous denial configuration may enable relatively more aggressive denials of uplink transmissions (relative to conventional techniques and thresholds). Each autonomous denial configuration may be associated with one or more parameters that indicate a validity cycle 315 and/or a validity window 320 (e.g., a validity window 320-a, a validity window 320-b, which may each be an example of a validity period). The autonomous denial configurations may further indicate a threshold parameter that configures a threshold quantity of denials 330 within a validity window 320. For example, an autonomous denial configuration may enable n 10 denials 330-a (e.g., 10 slots) within a validity window 320-a of n 20 (e.g., 20 slots). Such an autonomous denial configuration may therefore provide relatively greater opportunities for the UE 115 to utilize the denials 330-a for denying uplink transmissions and receive GNSS signaling in a corresponding GNSS reception window 305 (e.g., GNSS reception window 305-a).

In some cases, if the UE 115 if UE skips an uplink grant (e.g., a PUSCH grant) corresponding to an uplink transmission, for example, by using the denials 330 (e.g., the denials 330-a, the denials 330-b), a network entity 105 may determine that the UE 115 utilized such denials 330, and the network entity may avoid further uplink scheduling, for example, during a corresponding GNSS reception window 305. Further, the UE 115 may not need to utilize the denials 330 for each GNSS reception window 305, and the UE 115 may transmit a message indicating which GNSS reception window 305 of the one or more GNSS reception windows 305 for which the denials 330 are utilized. In such cases, the UE 115 may transmit a message indicating, to the network entity 105, that the autonomous denials 330 may only be used and/or activated in an indicated autonomous denials validity window 320. In some aspects, the indication may be transmitted by the UE 115 via RRC signaling (e.g., UE assistance information (UAI)), via MAC-CE signaling, via a PUCCH transmission, or the like.

In some examples, after the UE 115 receives the GNSS signaling (e.g., during a GNSS reception window 305), and before an end of a validity window 320, the UE 115 may transit one or more uplink signals to indicate to the network entity 105 that the UE 115 is ready for uplink transmissions. As an example, the UE 115 may transmit a random access message (e.g., via PRACH), a buffer status report (BSR), one or more signals via PUCCH, or any combination thereof, among other examples, which may indicate to the network entity 105 that the UE 115 is ready for one or more uplink transmissions. Additionally, or alternatively, the UE 115 may waits until an end of the validity window 320 to receive one or more messages scheduling the uplink transmissions. That is, the network entity 105 may transmit one or more uplink grants to the UE 115 after the end of the validity window 320, which may ensure that the UE 115 does not encounter any IDC interference issues that occur during a GNSS reception window 305.

In some aspects, the network entity 105 may configure the UE 115 with a validity cycle 315 during which the UE 115 is allowed to implement relatively aggressive autonomous denials 330. In some examples, the aggressive autonomous denials 330 may correspond more denials 330 than allowed in conventional autonomous denial configurations by some scaling factor (such as X times more than a currently configured autonomous denial value). The autonomous denials 330 may be utilized by the UE 115, for example, for receiving downlink GNSS signaling (and avoiding any IDC interference issues). In some examples, the one or more autonomous denial configurations corresponding to the autonomous denials 330 may be configured with a starting time interval and an ending time intervals (e.g., start at SFN=x and stop at SFN=y). In such cases, the UE 115 may activate the one or more autonomous denial configurations corresponding to the autonomous denials 330 in accordance with the starting time interval and the ending time interval. In some cases, the starting time interval and the ending time interval may correspond to and/or align with one or more GNSS reception windows 305 (e.g., GNSS reception window 305-a, GNSS reception window 305-b, and so forth).

In some aspects, a GNSS pattern (e.g., including one or more GNSS reception windows 305 and the period 310) may be configured via initial an initial configuration with a cell (e.g., via an RRC configuration). In some examples, the GNSS reception windows 305 and the period 310 may be configured via system information (e.g., via one or more system information blocks). In such examples, the UE 115 may determine whether a network entity 105 supports aggressive autonomous denial configuration based on one or more indications indicated via the system information. Additionally, or alternatively, a UE 115 may prioritize the selection of one or more cells based on whether those cells support the use of (aggressive) autonomous denials for IDC interference mitigation. In such cases, a network entity 105 may provide assistance information associated with one or more neighboring cells, which may enable the UE 115 to prioritize some cells during cell selection and/or cell reselection procedures.

In some examples, the UE 115 may transmit a capability message that indicates a capability (and/or a preference) of the UE 115 to support the relatively aggressive autonomous denials 330. For example, the UE 115 may transmit an indication of the capability and/or preference after associating with a cell (e.g., via an uplink message after completing a random access procedure).

As described herein, the autonomous denials 330 used for IDC interference mitigation may be dynamically activated and deactivated. As an example, the UE 115 may transmit a message requesting that one or more autonomous denial configurations be activated, for example, when an IDC interference issues is detected by the UE 115 (e.g., only when autonomous denials 330 are needed for IDC interference mitigation). In such cases, the UE 115 may transmit the request to activate the one or more autonomous denial configurations via MAC-CE signaling or via PUCCH signaling, or any combination thereof. In response, a network entity 105 may activate one or more autonomous denial configurations based on the request. For instance, the network entity may transmit an indication to activate one or more autonomous denial configurations via a PDCCH transmission (e.g., a message transmitted via PDCCH). In some aspects, the indication to activate the one or more autonomous denial configurations may be transmitted via MAC-CE signaling or via PDCCH signaling, or any combination thereof.

In some aspects, a network entity 105 may configure the UE 115 with multiple autonomous denial configurations, for example, via system information signaling or other signaling. As an example, the UE 115 may be configured with multiple autonomous denial configurations, and the UE 115 may indicate (e.g., via an uplink message) which autonomous denial configuration the UE 115 may use (e.g., during an GNSS reception window 305). Additionally, or alternatively, the network entity 105 may indicate (e.g., dynamically, semi-statically) to the UE 115, which autonomous denial configuration from the multiple autonomous denial configurations the UE 115 may use.

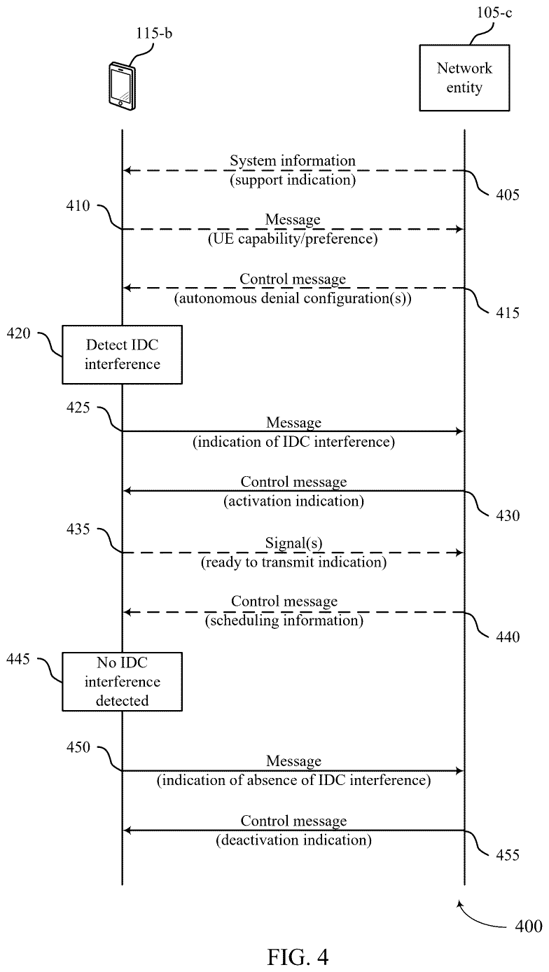

FIG. 4 shows an example of a process flow 400 that supports autonomous denial techniques for IDC interference in NTNs in accordance with one or more aspects of the present disclosure. In some cases, the process flow 400 may implement or be implemented by aspects of the wireless communications system 100, the wireless communications system 200, the GNSS reception windows 300, or any combination thereof. For example, the process flow 400 may include one or more UEs 115 (e.g., a UE 115-b) and one or more network entities 105 (e.g., a network entity 105-c), which may be respective examples of the corresponding devices as described herein. In the following description of the process flow 400, the operations between the UE 115-b and the network entity 105-c may be communicated in a different order than the example order shown, or the operations performed by the UE 115-b and the network entity 105-c may be performed in different orders or at different times. Some operations may also be omitted from the process flow 400, and other operations may be added to the process flow 400.

At 405, the network entity 105-c may output, and the UE 115-b may receive one or more messages indicating whether one or more cells support autonomous denial configurations. In some cases, the one or more message may be transmitted via system information and/or some other type of signaling. In any case, the UE 115-b may use the indication of whether a cell supports the one or more autonomous denial configuration for selecting (or re-selecting) a cell to communicate with.

At 410, the UE 115-b may transmit, and the network entity 105-c may obtain, a capability message that indicates whether the UE 115-b supports the one or more autonomous denial configurations (e.g., for at least one GNSS reception window). In some cases, the configuration message may additionally, or alternatively, indicate a preference for one or more autonomous denial configurations that may be used for IDC interference mitigation.

At 415, the network entity 105-c may output, and the UE 115-b may receive one or more control messages indicating a set of multiple autonomous denial configurations. In some examples, the one or more control messages may be an example of RRC signaling or other downlink signaling indicating the configuration of the set of multiple autonomous denial configurations. In some cases, the indication of the autonomous denial configurations may be received based on the capability message transmitted by the UE 115-b (e.g., at 410).

At 420, the UE 115-b may detect one or more IDC interference issues. For instance, the UE 115-b may determine that one or more scheduled uplink transmissions may possibly cause IDC interference for reception of one or more GNSS signals (e.g., corresponding to a GNSS reception window or during some other time interval). Additionally, or alternatively, the UE 115-b may determine that an ongoing uplink transmission may cause IDC interference for reception of the one or more GNSS signals. In some examples, the IDC interference may be associated with NTN communications or communications corresponding to one or more other radio access technologies.

At 425, the UE 115-b may transmit, and the network entity 105-c may obtain, a message indicating the detected IDC interference. For example, after the UE 115-b identifies that an IDC interference issue is present, the UE 115-b may transmit a message requesting that one or more autonomous denial configurations be activated to mitigate the detected IDC interference. In some cases, the message may be transmitted to the network entity 105-c based on the network entity 105-c being associated with a cell of one or more cells that supports the one or more autonomous denial configurations. In some examples, the message transmitted at 425 may include a request for an autonomous denial configuration from the set of autonomous denial configurations to be activated during at least one GNSS reception window.

At 430, the network entity 105-c may output, and the UE 115-b may obtain, a control message including an indication to activate the one or more autonomous denial configurations. In such cases, the UE 115-b may activate the one or more autonomous denial configurations in accordance with the control message received at 430, where the one or more autonomous denial configurations may be activated during at least one GNSS reception window configured for receiving GNSS signaling. In some examples, the one or more autonomous denial configurations indicated by the control message may be from the set of multiple autonomous denial configurations (e.g., indicated at 415). That is, the network entity 105-c may indicate which autonomous denial configuration the UE 115-b may use in the presence of IDC interference. Additionally, or alternatively, the control message may include an indication to activate an autonomous denial configuration requested by the UE 115-b. Here, an exchange of signaling between the UE 115-b and the network entity 105-c may be used to dynamically activate the one or more autonomous denial configurations used for mitigating detected IDC interference.

At 435, the UE 115-b may optionally transmit, to the network entity 105-c, one or more signals indicating that the UE 115-b is ready to transmit one or more uplink messages. In response (e.g., based on the one or more signals), and at 440, the network entity 105-c may output, and the UE 115-b may receive, a control message including an indication of an uplink grant scheduling resources for the one or more uplink messages. Additionally, or alternatively, the network entity 105-c may wait until an expiration of a GNSS reception window before outputting the control message including the uplink grant.

At 445, the UE 115-b may determine that the UE 115-b is no longer experiencing the IDC interference. In such cases, at 450, the UE 115-b may transmit, and the network entity 105-c may obtain, a message indicating an absence of the IDC interference (e.g., associated with NTN communications). At 455, the network entity 105-c may output, and the UE 115-b may receive, a control message including an indication to deactivate the one or more autonomous denial configurations. That is, an exchange of signaling between the UE 115-b and the network entity 105-c may be used to dynamically deactivate the one or more autonomous denial configurations used for mitigating IDC interference.

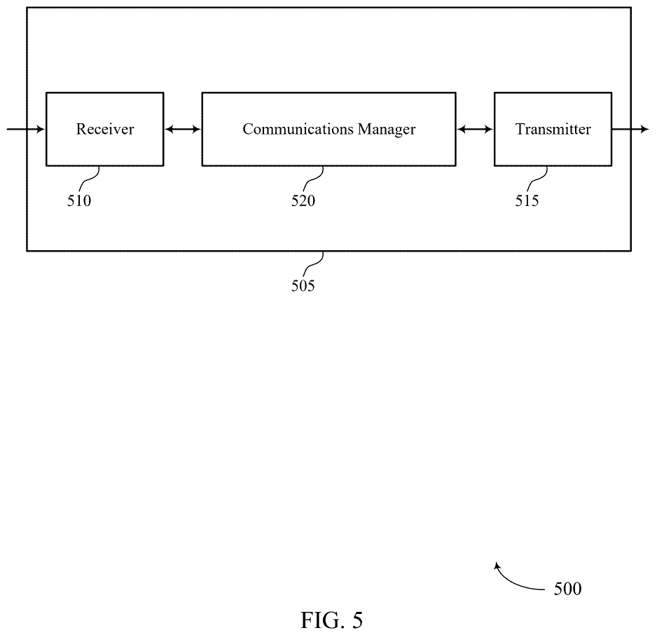

FIG. 5 shows a block diagram 500 of a device 505 that supports autonomous denial techniques for IDC interference in NTNs in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to autonomous denial techniques for IDC interference in NTNs). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to autonomous denial techniques for IDC interference in NTNs). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of autonomous denial techniques for IDC interference in NTNs as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for transmitting a first message indicating IDC interference associated with non-terrestrial network communications. The communications manager 520 is capable of, configured to, or operable to support a means for receiving, based on the first message, a first control message including an indication to activate one or more autonomous denial configurations. The communications manager 520 is capable of, configured to, or operable to support a means for receiving one or more global navigation satellite system (GNSS) signals during at least one GNSS reception window, where the one or more autonomous denial configurations are activated for the at least one GNSS reception window in accordance with the first control message.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for more efficient utilization of communication resources and improved interference mitigation. For example, the techniques supported by the device 505 may enable efficient procedures for activating relatively aggressive autonomous denial configurations in the presence of IDC interference. Likewise, by supporting the dynamic deactivation of such autonomous denial configurations, the device may support techniques that balance throughput with interference mitigation.

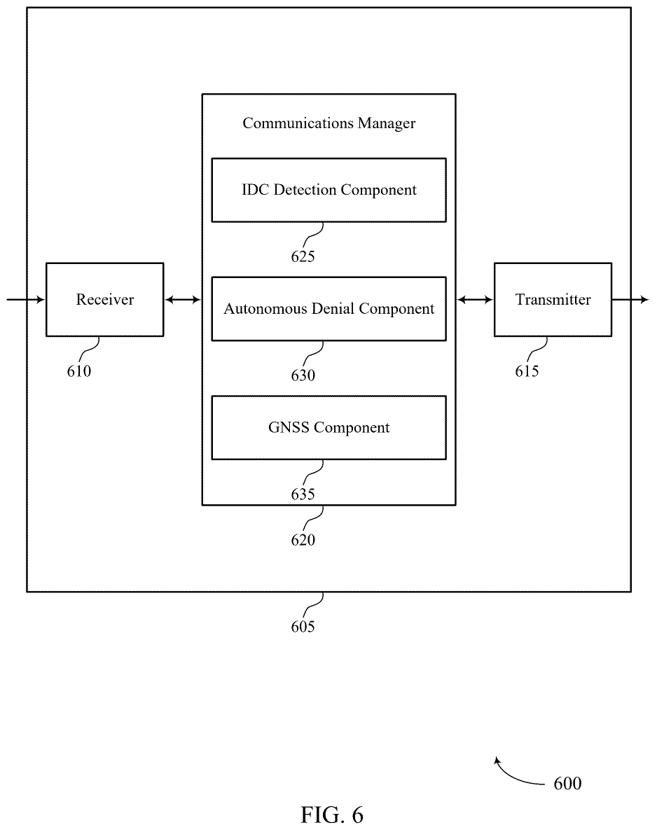

FIG. 6 shows a block diagram 600 of a device 605 that supports autonomous denial techniques for IDC interference in NTNs in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to autonomous denial techniques for IDC interference in NTNs). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to autonomous denial techniques for IDC interference in NTNs). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of autonomous denial techniques for IDC interference in NTNs as described herein. For example, the communications manager 620 may include an IDC detection component 625, an autonomous denial component 630, an GNSS component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The IDC detection component 625 is capable of, configured to, or operable to support a means for transmitting a first message indicating IDC interference associated with non-terrestrial network communications. The autonomous denial component 630 is capable of, configured to, or operable to support a means for receiving, based on the first message, a first control message including an indication to activate one or more autonomous denial configurations. The GNSS component 635 is capable of, configured to, or operable to support a means for receiving one or more global navigation satellite system (GNSS) signals during at least one GNSS reception window, where the one or more autonomous denial configurations are activated for the at least one GNSS reception window in accordance with the first control message.

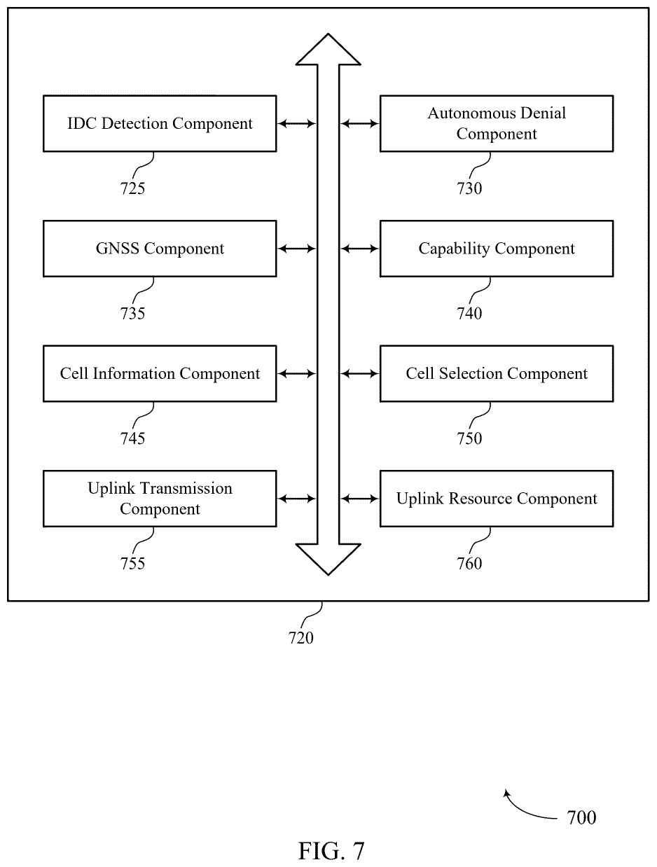

FIG. 7 shows a block diagram 700 of a communications manager 720 that supports autonomous denial techniques for IDC interference in NTNs in accordance with one or more aspects of the present disclosure. The communications manager 720 may be an example of aspects of a communications manager 520, a communications manager 620, or both, as described herein. The communications manager 720, or various components thereof, may be an example of means for performing various aspects of autonomous denial techniques for IDC interference in NTNs as described herein. For example, the communications manager 720 may include an IDC detection component 725, an autonomous denial component 730, an GNSS component 735, a capability component 740, a cell information component 745, a cell selection component 750, an uplink transmission component 755, an uplink resource component 760, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The IDC detection component 725 is capable of, configured to, or operable to support a means for transmitting a first message indicating IDC interference associated with non-terrestrial network communications. The autonomous denial component 730 is capable of, configured to, or operable to support a means for receiving, based on the first message, a first control message including an indication to activate one or more autonomous denial configurations. The GNSS component 735 is capable of, configured to, or operable to support a means for receiving one or more global navigation satellite system (GNSS) signals during at least one GNSS reception window, where the one or more autonomous denial configurations are activated for the at least one GNSS reception window in accordance with the first control message.

In some examples, the IDC detection component 725 is capable of, configured to, or operable to support a means for transmitting a second message indicating an absence of the IDC interference associated with the non-terrestrial network communications. In some examples, the autonomous denial component 730 is capable of, configured to, or operable to support a means for receiving, based on the second message, a second control message including an indication to deactivate the one or more autonomous denial configurations. In some examples, the first message includes an indication of one or more autonomous denial validity windows during which the one or more autonomous denial configurations are to be activated.

In some examples, the uplink transmission component 755 is capable of, configured to, or operable to support a means for transmitting one or more signals indicating that the UE is ready to transmit one or more uplink messages. In some examples, the uplink resource component 760 is capable of, configured to, or operable to support a means for receiving, based on the one or more signals, an uplink grant scheduling resources for transmitting the one or more uplink messages.

In some examples, the one or more signals are transmitted after receiving the one or more GNSS signals and prior to an expiration of an autonomous denial validity window of the one or more autonomous denial validity windows.

In some examples, the uplink resource component 760 is capable of, configured to, or operable to support a means for receiving an uplink grant scheduling resources for transmitting one or more uplink messages, where the uplink grant is received after an expiration of an autonomous denial validity window of the one or more autonomous denial validity windows.

In some examples, the one or more autonomous denial configurations each include a first threshold quantity of autonomous denial instances associated with an autonomous denial validity window. In some examples, the first threshold quantity of autonomous denial instances is greater a second threshold quantity of autonomous denial instances. In some examples, the first control message includes an indication of one or more starting instances and one or more ending instances associated with activating the one or more autonomous denial configurations.

In some examples, the autonomous denial component 730 is capable of, configured to, or operable to support a means for receiving one or more control messages indicating a set of autonomous denial configurations, where the one or more autonomous denial configurations indicated by the first control message are from the set of autonomous denial configurations.

In some examples, the autonomous denial component 730 is capable of, configured to, or operable to support a means for transmitting a third message requesting an autonomous denial configuration from the set of autonomous denial configurations for activation during the at least one GNSS reception window, where the indication to activate the one or more autonomous denial configurations is based on the third message, the one or more autonomous denial configurations including the autonomous denial configuration.

In some examples, the first control message indicates which autonomous denial configuration from the set of autonomous denial configurations is to be activated during the at least one GNSS reception window.

In some examples, the capability component 740 is capable of, configured to, or operable to support a means for transmitting a capability message that indicates that the UE supports the one or more autonomous denial configurations for the at least one GNSS reception window.

In some examples, the cell information component 745 is capable of, configured to, or operable to support a means for receiving one or more messages indicating whether one or more cells support the one or more autonomous denial configurations for the at least one GNSS reception window, where the first message is transmitted to a network entity associated with a cell of the one or more cells that supports the one or more autonomous denial configurations.

In some examples, the cell selection component 750 is capable of, configured to, or operable to support a means for selecting one or more cells that support the one or more autonomous denial configurations for the at least one GNSS reception window based on a ranking of the one or more cells.

In some examples, the cell information component 745 is capable of, configured to, or operable to support a means for receiving an indication of whether one or more neighboring cells support the one or more autonomous denial configurations. In some examples, the cell selection component 750 is capable of, configured to, or operable to support a means for selecting a cell of the one or more neighboring cells based on the cell supporting the one or more autonomous denial configurations.

In some examples, the GNSS component 735 is capable of, configured to, or operable to support a means for receiving one or more control messages configuring a set of GNSS reception windows, where the one or more autonomous denial configurations are activated for the at least one GNSS reception window based on the set of GNSS reception windows.

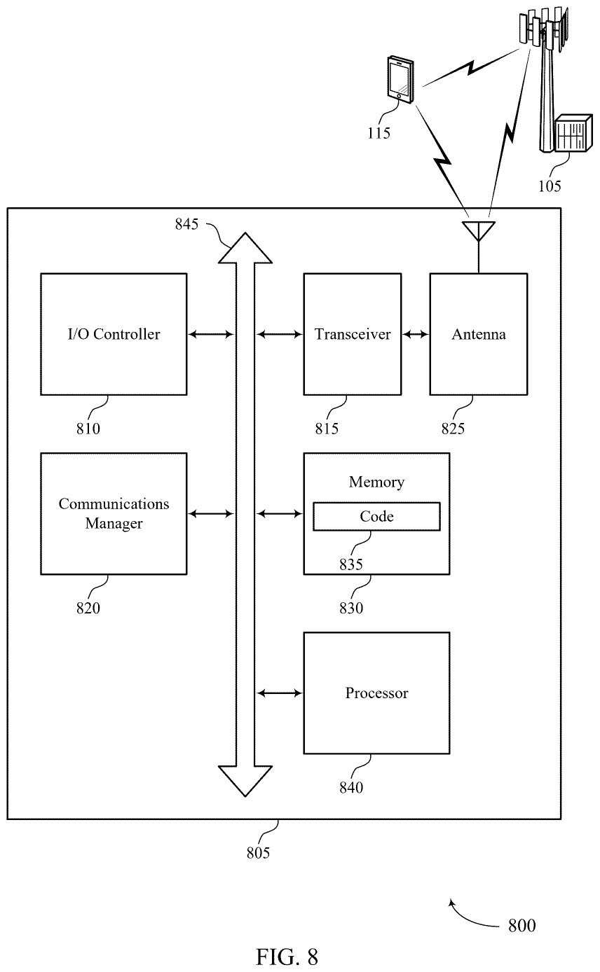

FIG. 8 shows a diagram of a system 800 including a device 805 that supports autonomous denial techniques for IDC interference in NTNs in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting autonomous denial techniques for IDC interference in NTNs). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for transmitting a first message indicating IDC interference associated with non-terrestrial network communications. The communications manager 820 is capable of, configured to, or operable to support a means for receiving, based on the first message, a first control message including an indication to activate one or more autonomous denial configurations. The communications manager 820 is capable of, configured to, or operable to support a means for receiving one or more global navigation satellite system (GNSS) signals during at least one GNSS reception window, where the one or more autonomous denial configurations are activated for the at least one GNSS reception window in accordance with the first control message.

By including or configuring the communications manager 820 in accordance with examples as described herein, the device 805 may support techniques for improved communication reliability, reduced latency, reduced power consumption, more efficient utilization of communication resources, improved coordination between devices, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of autonomous denial techniques for IDC interference in NTNs as described herein, or the at least one processor 840 and the at least one memory 830 may be otherwise configured to, individually or collectively, perform or support such operations.

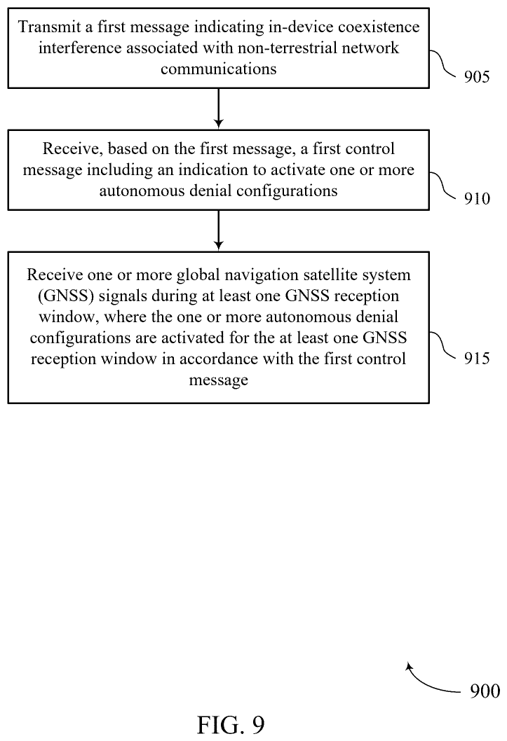

FIG. 9 shows a flowchart illustrating a method 900 that supports autonomous denial techniques for IDC interference in NTNs in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include transmitting a first message indicating IDC interference associated with non-terrestrial network communications. The operations of 905 may be performed in accordance with examples as disclosed herein. In some examples, aspects of the operations of 905 may be performed by an IDC detection component 725 as described with reference to FIG. 7.

At 910, the method may include receiving, based on the first message, a first control message including an indication to activate one or more autonomous denial configurations. The operations of 910 may be performed in accordance with examples as disclosed herein. In some examples, aspects of the operations of 910 may be performed by an autonomous denial component 730 as described with reference to FIG. 7.

At 915, the method may include receiving one or more global navigation satellite system (GNSS) signals during at least one GNSS reception window, where the one or more autonomous denial configurations are activated for the at least one GNSS reception window in accordance with the first control message. The operations of 915 may be performed in accordance with examples as disclosed herein. In some examples, aspects of the operations of 915 may be performed by an GNSS component 735 as described with reference to FIG. 7.

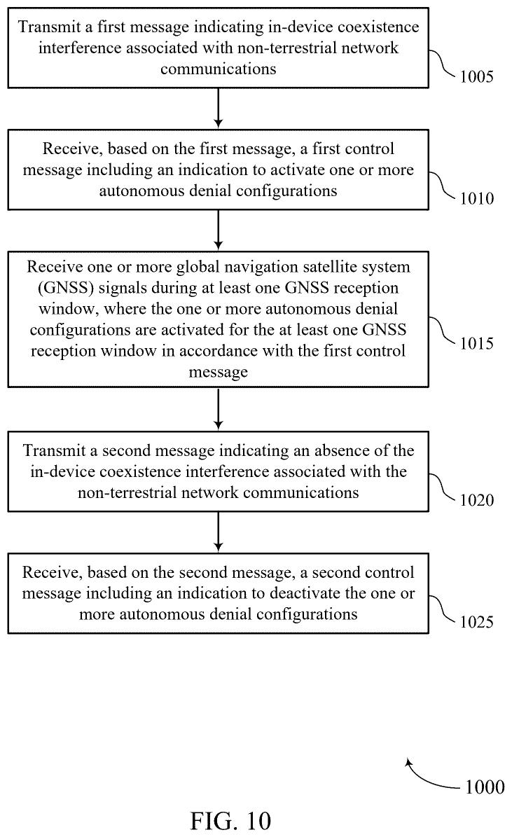

FIG. 10 shows a flowchart illustrating a method 1000 that supports autonomous denial techniques for IDC interference in NTNs in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include transmitting a first message indicating IDC interference associated with non-terrestrial network communications. The operations of 1005 may be performed in accordance with examples as disclosed herein. In some examples, aspects of the operations of 1005 may be performed by an IDC detection component 725 as described with reference to FIG. 7.

At 1010, the method may include receiving, based on the first message, a first control message including an indication to activate one or more autonomous denial configurations. The operations of 1010 may be performed in accordance with examples as disclosed herein. In some examples, aspects of the operations of 1010 may be performed by an autonomous denial component 730 as described with reference to FIG. 7.

At 1015, the method may include receiving one or more global navigation satellite system (GNSS) signals during at least one GNSS reception window, where the one or more autonomous denial configurations are activated for the at least one GNSS reception window in accordance with the first control message. The operations of 1015 may be performed in accordance with examples as disclosed herein. In some examples, aspects of the operations of 1015 may be performed by an GNSS component 735 as described with reference to FIG. 7.

At 1020, the method may include transmitting a second message indicating an absence of the IDC interference associated with the non-terrestrial network communications. The operations of 1020 may be performed in accordance with examples as disclosed herein. In some examples, aspects of the operations of 1020 may be performed by an IDC detection component 725 as described with reference to FIG. 7.

At 1025, the method may include receiving, based on the second message, a second control message including an indication to deactivate the one or more autonomous denial configurations. The operations of 1025 may be performed in accordance with examples as disclosed herein. In some examples, aspects of the operations of 1025 may be performed by an autonomous denial component 730 as described with reference to FIG. 7.

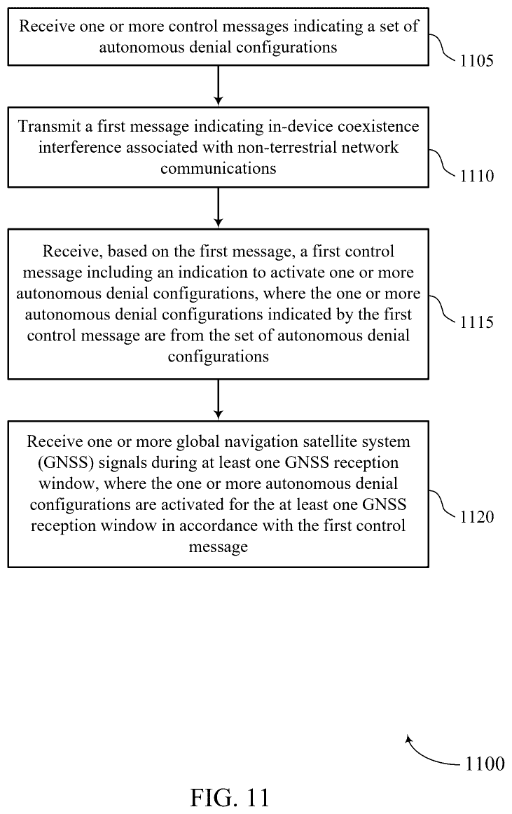

FIG. 11 shows a flowchart illustrating a method 1100 that supports autonomous denial techniques for IDC interference in NTNs in accordance with one or more aspects of the present disclosure. The operations of the method 1100 may be implemented by a UE or its components as described herein. For example, the operations of the method 1100 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1105, the method may include receiving one or more control messages indicating a set of autonomous denial configurations. The operations of 1105 may be performed in accordance with examples as disclosed herein. In some examples, aspects of the operations of 1105 may be performed by an autonomous denial component 730 as described with reference to FIG. 7.

At 1110, the method may include transmitting a first message indicating IDC interference associated with non-terrestrial network communications. The operations of 1110 may be performed in accordance with examples as disclosed herein. In some examples, aspects of the operations of 1110 may be performed by an IDC detection component 725 as described with reference to FIG. 7.

At 1115, the method may include receiving, based on the first message, a first control message including an indication to activate one or more autonomous denial configurations, where the one or more autonomous denial configurations indicated by the first control message are from the set of autonomous denial configurations. The operations of 1115 may be performed in accordance with examples as disclosed herein. In some examples, aspects of the operations of 1115 may be performed by an autonomous denial component 730 as described with reference to FIG. 7.

At 1120, the method may include receiving one or more global navigation satellite system (GNSS) signals during at least one GNSS reception window, where the one or more autonomous denial configurations are activated for the at least one GNSS reception window in accordance with the first control message. The operations of 1120 may be performed in accordance with examples as disclosed herein. In some examples, aspects of the operations of 1120 may be performed by an GNSS component 735 as described with reference to FIG. 7.

The following provides an overview of aspects of the present disclosure:
Aspect 1: A method for wireless communications by a UE, comprising: transmitting a first message indicating in-device coexistence interference associated with non-terrestrial network communications; receiving, based at least in part on the first message, a first control message comprising an indication to activate one or more autonomous denial configurations; and receiving one or more global navigation satellite system (GNSS) signals during at least one GNSS reception window, wherein the one or more autonomous denial configurations are activated for the at least one GNSS reception window in accordance with the first control message.
Aspect 2: The method of aspect 1, further comprising: transmitting a second message indicating an absence of the in-device coexistence interference associated with the non-terrestrial network communications; and receiving, based at least in part on the second message, a second control message comprising an indication to deactivate the one or more autonomous denial configurations.
Aspect 3: The method of any of aspects 1 through 2, wherein the first message comprises an indication of one or more autonomous denial validity windows during which the one or more autonomous denial configurations are to be activated.
Aspect 4: The method of aspect 3, further comprising: transmitting one or more signals indicating that the UE is ready to transmit one or more uplink messages; and receiving, based at least in part on the one or more signals, an uplink grant scheduling resources for transmitting the one or more uplink messages.
Aspect 5: The method of aspect 4, wherein the one or more signals are transmitted after receiving the one or more GNSS signals and prior to an expiration of an autonomous denial validity window of the one or more autonomous denial validity windows.
Aspect 6: The method of any of aspects 3 through 5, further comprising: receiving an uplink grant scheduling resources for transmitting one or more uplink messages, wherein the uplink grant is received after an expiration of an autonomous denial validity window of the one or more autonomous denial validity windows.
Aspect 7: The method of aspect 1, wherein the one or more autonomous denial configurations each comprise a first threshold quantity of autonomous denial instances associated with an autonomous denial validity window, the first threshold quantity of autonomous denial instances is greater a second threshold quantity of autonomous denial instances.
Aspect 8: The method of aspect 7, wherein the first control message comprises an indication of one or more starting instances and one or more ending instances associated with activating the one or more autonomous denial configurations.
Aspect 9: The method of any of aspects 1 through 8, further comprising: receiving one or more control messages indicating a set of autonomous denial configurations, wherein the one or more autonomous denial configurations indicated by the first control message are from the set of autonomous denial configurations.
Aspect 10: The method of aspect 9, further comprising: transmitting a third message requesting an autonomous denial configuration from the set of autonomous denial configurations for activation during the at least one GNSS reception window, wherein the indication to activate the one or more autonomous denial configurations is based at least in part on the third message, the one or more autonomous denial configurations including the autonomous denial configuration.
Aspect 11: The method of any of aspects 9 through 10, wherein the first control message indicates which autonomous denial configuration from the set of autonomous denial configurations is to be activated during the at least one GNSS reception window.
Aspect 12: The method of any of aspects 1 through 11, further comprising: transmitting a capability message that indicates that the UE supports the one or more autonomous denial configurations for the at least one GNSS reception window.
Aspect 13: The method of any of aspects 1 through 12, further comprising: receiving one or more messages indicating whether one or more cells support the one or more autonomous denial configurations for the at least one GNSS reception window, wherein the first message is transmitted to a network entity associated with a cell of the one or more cells that supports the one or more autonomous denial configurations.
Aspect 14: The method of any of aspects 1 through 13, further comprising: selecting one or more cells that support the one or more autonomous denial configurations for the at least one GNSS reception window based at least in part on a ranking of the one or more cells.
Aspect 15: The method of any of aspects 1 through 14, further comprising: receiving an indication of whether one or more neighboring cells support the one or more autonomous denial configurations; and selecting a cell of the one or more neighboring cells based at least in part on the cell supporting the one or more autonomous denial configurations.
Aspect 16: The method of any of aspects 1 through 15, further comprising: receiving one or more control messages configuring a set of GNSS reception windows, wherein the one or more autonomous denial configurations are activated for the at least one GNSS reception window based at least in part on the set of GNSS reception windows.
Aspect 17: A UE for wireless communications, comprising one or more memories storing processor-executable code, and one or more processors coupled with the one or more memories and individually or collectively operable to execute the code to cause the UE to perform a method of any of aspects 1 through 16.
Aspect 18: A UE for wireless communications, comprising at least one means for performing a method of any of aspects 1 through 16.
Aspect 19: A non-transitory computer-readable medium storing code for wireless communications, the code comprising instructions executable by one or more processors to perform a method of any of aspects 1 through 16.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit a first message indicating in-device coexistence interference associated with non-terrestrial network communications;
receive, based at least in part on the first message, a first control message comprising an indication to activate one or more autonomous denial configurations; and
receive one or more global navigation satellite system (GNSS) signals during at least one GNSS reception window, wherein the one or more autonomous denial configurations are activated for the at least one GNSS reception window in accordance with the first control message.

2. The UE of claim 1, wherein the one or more processors are individually or collectively further operable to execute the code to cause the UE to:
transmit a second message indicating an absence of the in-device coexistence interference associated with the non-terrestrial network communications; and
receive, based at least in part on the second message, a second control message comprising an indication to deactivate the one or more autonomous denial configurations.

3. The UE of claim 1, wherein the first message comprises an indication of one or more autonomous denial validity windows during which the one or more autonomous denial configurations are to be activated.

4. The UE of claim 3, wherein the one or more processors are individually or collectively further operable to execute the code to cause the UE to:
transmit one or more signals indicating that the UE is ready to transmit one or more uplink messages; and
receive, based at least in part on the one or more signals, an uplink grant scheduling resources for transmitting the one or more uplink messages.

5. The UE of claim 4, wherein the one or more signals are transmitted after receiving the one or more GNSS signals and prior to an expiration of an autonomous denial validity window of the one or more autonomous denial validity windows.

6. The UE of claim 3, wherein the one or more processors are individually or collectively further operable to execute the code to cause the UE to:
receive an uplink grant scheduling resources for transmitting one or more uplink messages, wherein the uplink grant is received after an expiration of an autonomous denial validity window of the one or more autonomous denial validity windows.

7. The UE of claim 1, wherein the one or more autonomous denial configurations each comprise a first threshold quantity of autonomous denial instances associated with an autonomous denial validity window, and wherein the first threshold quantity of autonomous denial instances is greater a second threshold quantity of autonomous denial instances.

8. The UE of claim 7, wherein the first control message comprises an indication of one or more starting instances and one or more ending instances associated with activating the one or more autonomous denial configurations.

9. The UE of claim 1, wherein the one or more processors are individually or collectively further operable to execute the code to cause the UE to:
receive one or more control messages indicating a set of autonomous denial configurations, wherein the one or more autonomous denial configurations indicated by the first control message are from the set of autonomous denial configurations.

10. The UE of claim 9, wherein the one or more processors are individually or collectively further operable to execute the code to cause the UE to:
transmit a third message requesting an autonomous denial configuration from the set of autonomous denial configurations for activation during the at least one GNSS reception window, wherein the indication to activate the one or more autonomous denial configurations is based at least in part on the third message, the one or more autonomous denial configurations including the autonomous denial configuration.

11. The UE of claim 9, wherein the first control message indicates which autonomous denial configuration from the set of autonomous denial configurations is to be activated during the at least one GNSS reception window.

12. The UE of claim 1, wherein the one or more processors are individually or collectively further operable to execute the code to cause the UE to:
transmit a capability message that indicates that the UE supports the one or more autonomous denial configurations for the at least one GNSS reception window.

13. The UE of claim 1, wherein the one or more processors are individually or collectively further operable to execute the code to cause the UE to:
receive one or more messages indicating whether one or more cells support the one or more autonomous denial configurations for the at least one GNSS reception window, wherein the first message is transmitted to a network entity associated with a cell of the one or more cells that supports the one or more autonomous denial configurations.

14. The UE of claim 1, wherein the one or more processors are individually or collectively further operable to execute the code to cause the UE to:
select one or more cells that support the one or more autonomous denial configurations for the at least one GNSS reception window based at least in part on a ranking of the one or more cells.

15. The UE of claim 1, wherein the one or more processors are individually or collectively further operable to execute the code to cause the UE to:
receive an indication of whether one or more neighboring cells support the one or more autonomous denial configurations; and
select a cell of the one or more neighboring cells based at least in part on the cell supporting the one or more autonomous denial configurations.

16. The UE of claim 1, wherein the one or more processors are individually or collectively further operable to execute the code to cause the UE to:
receive one or more control messages configuring a set of GNSS reception windows, wherein the one or more autonomous denial configurations are activated for the at least one GNSS reception window based at least in part on the set of GNSS reception windows.

17. A method for wireless communications by a user equipment (UE), comprising:
transmitting a first message indicating in-device coexistence interference associated with non-terrestrial network communications;
receiving, based at least in part on the first message, a first control message comprising an indication to activate one or more autonomous denial configurations; and
receiving one or more global navigation satellite system (GNSS) signals during at least one GNSS reception window, wherein the one or more autonomous denial configurations are activated for the at least one GNSS reception window in accordance with the first control message.

18. The method of claim 17, further comprising:
transmitting a second message indicating an absence of the in-device coexistence interference associated with the non-terrestrial network communications; and
receiving, based at least in part on the second message, a second control message comprising an indication to deactivate the one or more autonomous denial configurations.

19. The method of claim 17, further comprising:
receiving one or more control messages indicating a set of autonomous denial configurations, wherein the one or more autonomous denial configurations indicated by the first control message are from the set of autonomous denial configurations.

20. A user equipment (UE) for wireless communications, comprising:
means for transmitting a first message indicating in-device coexistence interference associated with non-terrestrial network communications;
means for receiving, based at least in part on the first message, a first control message comprising an indication to activate one or more autonomous denial configurations; and
means for receiving one or more global navigation satellite system (GNSS) signals during at least one GNSS reception window, wherein the one or more autonomous denial configurations are activated for the at least one GNSS reception window in accordance with the first control message.
